(19) United States
(12) Patent Application Publication
(10) Pub. No.: US 2018/0106433 A1
(43) Pub. Date: Apr. 19, 2018

(54) BULB AND BULB HOLDER ADAPTER KIT

(71) Applicant: Oktalite Technology Limited, Jiangmen City (CN)

(72) Inventor: Max ., Jiangmen City (CN)

(21) Appl. No.: 15/296,711

(22) Filed: Oct. 18, 2016

(51) Int. Cl. F21K 9/235; F21K 9/232

(52) U.S. Cl. CPC F21K 9/235; F21K 9/232

(57) ABSTRACT

The present invention discloses a bulb and bulb holder adapter kit, comprising an LED bulb body provided with a bottom interface and a lateral interface, and an bulb holder assembly comprising at least one first adapter and at least one second adapter. Each of the first adapter and the second adapter comprises at one end a screw portion, a first contact and a second contact, and at the other end an insertion portion and terminals. The screw portion and the LED bulb body are connected by matched screw threads, and the insertion portion is provided with a square column and pins. Each of the first adapter and the second adapter comprises a housing sleeved on the screw portion, and the first adapter further comprises an intermediate housing between the screw portion and the housing thereof.

### FIELD OF THE INVENTION

The invention relates to a set of lamp adapters, and in particular to a bulb and bulb holder adapter kit.

### BACKGROUND

For modern LED lamps, bulb holders and bulbs are often integrally assembled during a production process for higher efficiency, assembly balance rate and product consistency, the resulting bulb holders of the LED lamps are generally irreplaceable. In this way, the application range of the LED lamps with fixed bulb holders is narrowed, because the bulbs of the LED lamps are designed to connect to only one dedicated type of sockets but there are many types of sockets in different countries and even there are many sockets with different specifications in the same country. In many cases the LED lamps can't be used due to the mismatching of the bulb holders and the sockets.

The bulb holders are fragile as they are usually squeezed. Likewise, the LED bulbs are also fragile parts, therefore it is necessary to consider problems regarding the replacement of the malfunctioned or damaged bulb holders and/or LED bulbs in use. However, for the LED lamps with the irreplaceable bulb holders, it's very difficult to disassemble the LED lamps to replace the malfunctioned or damaged parts once the LED lamps are produced or deployed, in the case where the LED lamps do not work. The LED lamps therefore must be replaced by new ones, causing greatly waste.

Therefore, a novel lamp assembly with advantages of easy disassembly, maintenance and replacement is needed.

### SUMMARY OF THE INVENTION

Aiming at solving the technical problems mentioned above, the present invention provides a bulb and bulb holder adapter kit. In detail, the adapter kit comprises an LED bulb body comprising a bottom interface and a lateral interface. The adapter kit further comprises a bulb holder assembly, which comprises at least one first adapter and at least one second adapter, each of which is provided at one end thereof with a screw portion, a first contact configured to connect with the bottom interface and a second contact configured to connect with the lateral interface, and at the other end thereof with an insertion portion and terminals connected with the first contact and the second contact respectively. The screw portion and the LED bulb body are provided with screw threads matched therebetween. The insertion portion comprises a square column for fixing the first adapter or the second adapter onto a socket, and pins arranged on two opposing sides of the square column. Each of the first adapter and the second adapter comprises a housing sleeved on the screw portion, and the first adapter further comprises an intermediate housing arranged between the screw portion and the housing.

Preferably, the insertion portion further comprises a boss having a kidney or rounded rectangular cross section, for connecting the square column and the housing.

Preferably, the insertion portion comprises at least two terminals, each of which at one end thereof is connected to the first contact and the second contact respectively and at the other end thereof extents through in turn and protrudes from the housing and the boss.

Preferably, the boss has a kidney-shaped cross section and the terminals are arranged on two arc ends of the boss.

Preferably, the boss has a rounded rectangular cross section, and the insertion portion comprises four terminals arranged on four corners of the rectangle, or two terminals arranged on two opposing corners of either of diagonals of the rectangle.

Preferably, the square column is provided with one or two pins on each of two opposing sides thereof.

Preferably, the length of the square column of the first adapter is larger than it of the square column of the second adapter.

Preferably, the boss of the first adapter has a rounded square cross section, and the boss of the second adapter has a rounded rectangle cross section, wherein a long side of the rounded rectangle is equal to a side of the rounded square, and a short side of the rounded rectangle is less than the side of the rounded square.

Preferably, the intermediate housing is provided with a guide groove on an outer wall thereof, the housing of the first adapter is provided on an inner wall thereof with a bump slidable in the guide groove.

The present invention has the beneficial effects that: compared with the adapter of the prior art, a bulb and bulb holder adapter kit according to the invention comprises a bulb holder assembly adapted to sockets of different types to enable the same bulb to be used for the sockets of different types, resulting in a much wider application range; and the maintenance and replacement of the bulb and the bulb holder assembly can be conducted separately, thereby providing convenience and efficiency and lowering the cost of maintenance.

### BRIEF DESCRIPTION OF THE DRAWINGS

The present invention will be further described in details hereinafter by embodiments and with reference to the drawings, wherein:

FIG. 1 is an overall schematic view of an adapter kit according to the invention;

FIG. 2 is a top view of a first adapter;

FIG. 3 is a side view of a first adapter inverted;

FIG. 4 is a side view of another first adapter inverted;

FIG. 5 is a bottom view of an intermediate housing of the first adapters;

FIG. 6 is a top view of a housing of the first adapters;

FIG. 7 is a top view of the intermediate housing of the first adapters;

FIG. 8 is a top view of a second adapter;

FIG. 9 is a top view of the second adapters with a screw part removed;

FIG. 10 is a side view of a second adapter inverted;

FIG. 11 is a side view of another second adapter inverted;

FIG. 12 is a side view of a LED bulb body;

FIG. 13 is a top view of the LED bulb body.

### DETAILED DESCRIPTION

The following embodiments are given to illustrate the overall structure of a bulb and bulb holder adapter kit.

### First Embodiment

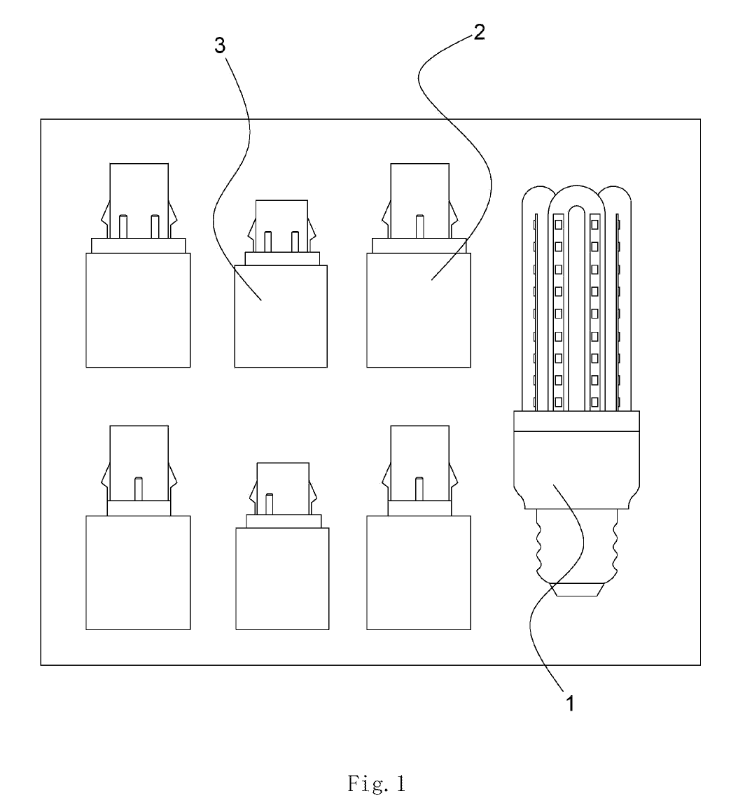

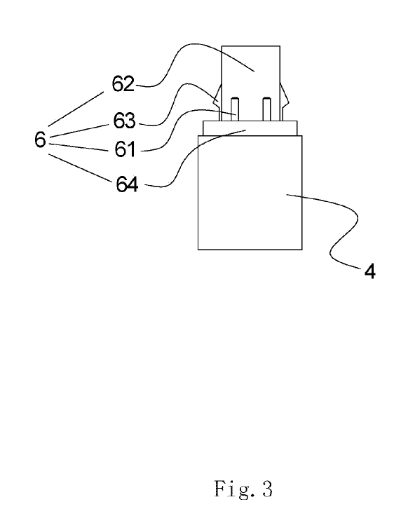

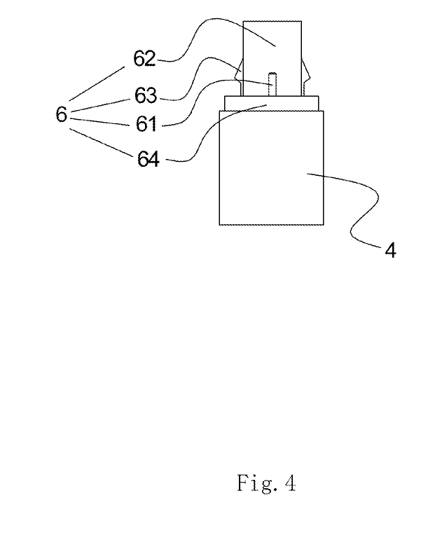

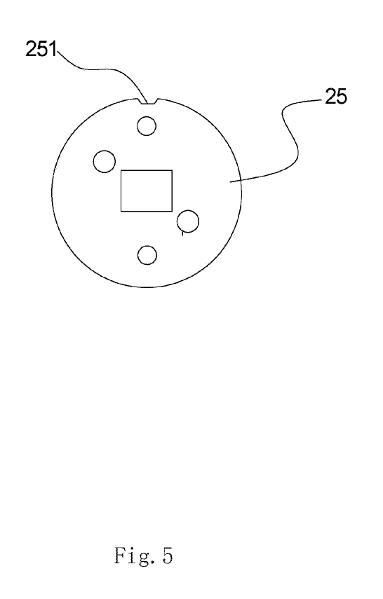

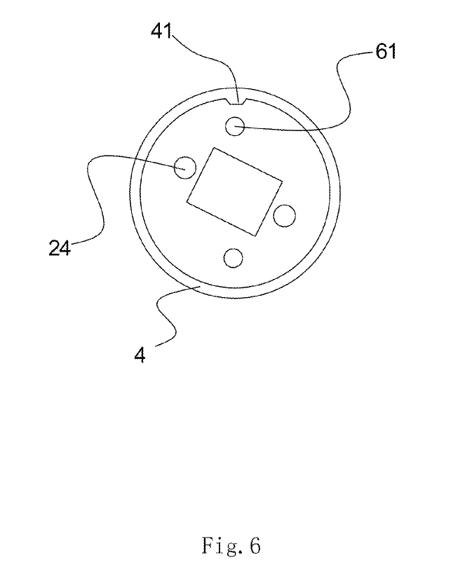

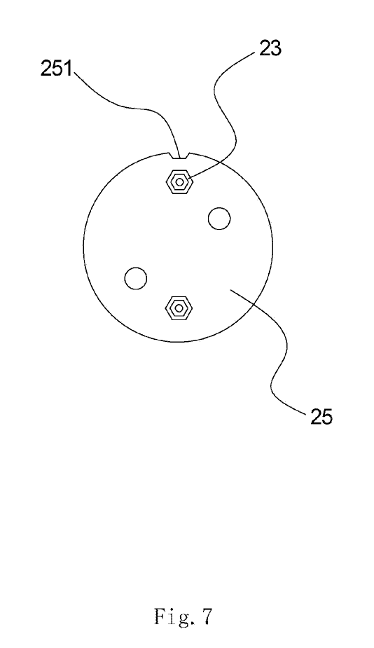

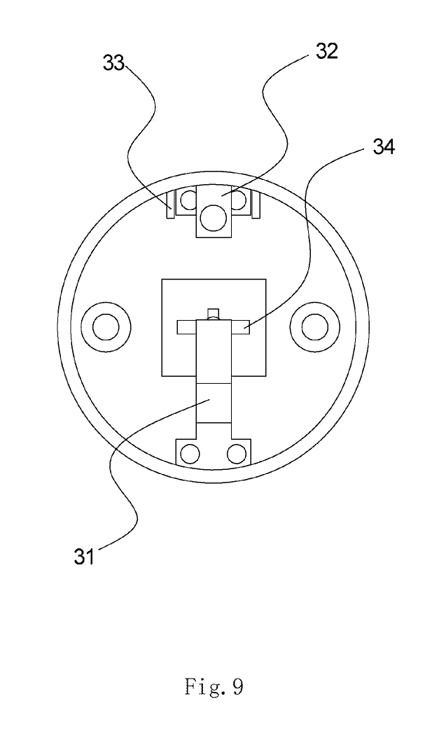

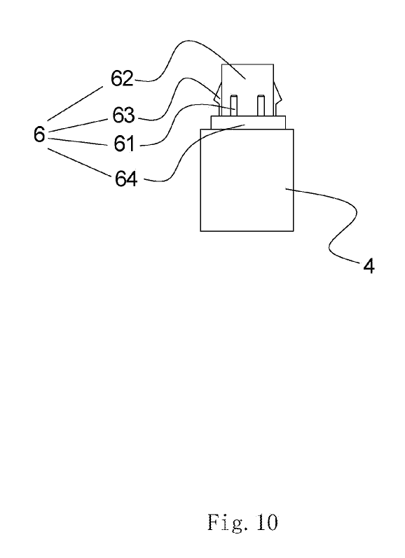

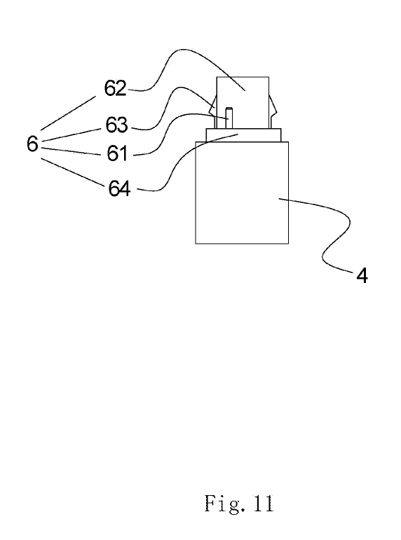

As shown in FIGS. 1 to 13, a bulb and bulb holder adapter kit comprises an LED bulb body 1 and a bulb holder assembly, wherein the LED bulb body 1 is provided with a bottom interface 11 and a lateral interface 12, and the bulb holder assembly comprises at least one first adapter 2 and at least one second adapter 3. Each of the first adapter 2 and the second adapter 3 is provided at one end with a screw portion 5, a first contact configured to connect to the bottom interface 11 and a second contact configured to connect to the lateral interface 12, and at the other end with an insertion portion 6 and terminals 61 connected with the first contact and the second contact respectively. The screw portion 5 and the LED bulb body 1 are secured with each other by matching screw threads. The insertion portion 6 comprises a square column 62 for fixing the first adapter 2 or the second adapter 3 on sockets, and pins 63 arranged on two opposing sides of the square column 62. Each of the first adapter 2 and the second adapter 3 further comprises a housing 4 sleeved on the screw portion 5, and the first adapter 2 further comprises an intermediate housing 25 arranged between the screw portion 5 and the housing 4. The housings 4 of the first adapter 2 and the second adapter 3 are cylindrical, and the cylindrical surface radius of the housing 4 of the first adapter 2 is greater than it of the housing 4 of the second adapter 3 for adaption to various recesses of different sockets. In this case the intermediate housing 25 is used as compensation for difference of the cylindrical surface radius.

The housing 4 is configured to enclose the internal structures of each of the first adapter 2 and the second adapter 3 for a protective purpose. The size of the housing 4 of the first adapter 2 is larger than it of the housing 4 of the second adapter 3, and the size of the screw portion 5 of the first adapter 2 is the same as it of the screw portion 5 of the second adapter 3, and thus the intermediate housing 25 is required in the first adapter 2 for adaption to the larger housings 4 of the first adapter 2.

The insertion portion 6 further comprises a boss 64 configured to connect the square column 62 and the housing 4, and the boss 64 may have a kidney-shaped or rounded rectangular cross section corresponding to a cross section of the recess receiving the boss 64 inserted in the socket. Recesses in sockets of different types mainly have a kidney-shaped or rounded rectangular cross section.

At least two terminals 61 are comprised. In the case of two terminals 61, they are at one end connected to the first contact and the second contact respectively and at the other end extent through in turn and protrude from the housing 4 and the boss 64. The number of the terminals 61 is equivalent to the number of holes in the socket, into which the terminals 61 are inserted, and particularly two or four holes are provided in the socket. Regarding the first adapter 2, the terminals 61 are arranged on two arc ends of the boss 64 in the case where two terminals 61 are comprised and the boss 64 has a kidney-shaped cross section; regarding the second adapter 3, the terminals 61 are arranged on two opposing corners of either of the two diagonals of a rectangle in the case where two terminals 61 are comprised and the boss 64 has a rounded rectangular cross section; in the case where each of the first adapter 2 and the second adapter 3 comprises four terminals 61 and the bosses 64 have a rounded rectangular cross section, the four terminals 61 are arranged on four corners of another rectangle on each of the bosses 64, respectively.

The insertion portion 6 is provided with one or more pins 63 on two opposing sides of the square column 62, for buckling the square column 62 into the socket, thereby fixing the bulb to the bulb holder assembly.

The length of the square column 62 of the first adapter 2 is larger than it of the square column 62 of the second adapters 3, for adaption to recesses of different depths.

In the case where the boss 64 of the first adapter 2 has a rounded square cross section and the boss 64 of the second adapter 3 has a rounded rectangular cross section, the length of a long side of the rounded rectangle is equal to it of a side of the rounded square, and the length of a short side of the rounded rectangle is less than it of the side of the rounded square.

The intermediate housing 25 is provided with a guide groove 251 on an outside wall thereof, and the housing 4 of the first adapter 2 is provided with a bump 41 on an inside wall thereof, which is capable of sliding in the guide groove 251. By means of the guide groove 251 in cooperation with the bump 41, the intermediate housing 25 can be connected to the housing 4 in a fixed position, thereby providing convenience for assembling and disassembling.

The following embodiment is given to illustrate the bulb holder assembly in the first embodiment.

### Second Embodiment

As shown in FIGS. 1 to 11, the bulb holder assembly comprises four first adapters 2 and two second adapters 3, wherein a first first adapter 2 comprises four terminals 61 and two pins 63 and has a rounded square cross section; a second first adapter 2 comprises two terminals 61 and two pins 63 and has a rounded square cross section; a third first adapter 2 comprises two terminals 61 and two pins 63 and has a kidney-shaped cross section; and a fourth first adapters 2 comprises two terminals 61 and four pins 63 and has a kidney-shaped cross section. A first second adapter 3 comprises four terminals 61 and two pins 63 and has a rounded rectangular cross section; and a second second adapter 3 comprises two terminals 61 and two pins 63 and has a rounded rectangular cross section.

The first adapters 2 of the bulb holder assembly, in combination with the second adapters 3, can convert a threaded connection between the LED bulb body 1 and the socket into a connection by the pins 63 and the terminals 61, allowing the adapter kit in this embodiment to be adaptive to the sockets of many types with a type G interface which are common today in many countries, in the case of using only the same one LED bulb body 1. Resulting from above, the LED bulb body 1 can be used more widely, and disassembly, replacement and maintenance of lamp parts can be more convenient.

The following embodiment is given to illustrate the first contact and the second contact in the first embodiment.

### Third Embodiment

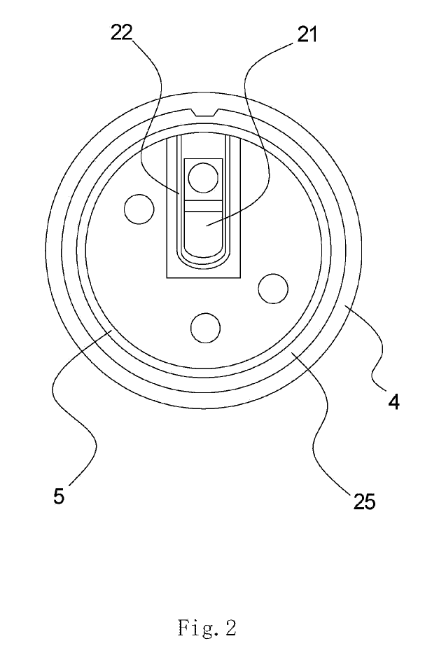

As shown in FIGS. 2 to 7, the first contact of the first adapter 2 is a first metal shrapnel 21 fixed on the intermediate housing 25 and having an elastic portion corresponding to the bottom interface 11 of the LED bulb body 1. The second contact of the first adapter 2 is the conductive screw portion 5 fixed on the intermediate housing 25, wherein the screw portion 5 has a space in a position corresponding to the bottom interface 11 of the LED bulb body 1, for receiving the first metal shrapnel 21. The first adapter 2 is provided with a baffle 22 arranged between the screw portion 5 and the first metal shrapnel 21. The screw portion 5 is fixed on the intermediate housing 25 by matching screws and screw caps. Specifically, the intermediate housing 25 is provided with fixing bases 23 matched in shape with the screw caps on a back side thereof for receiving and securing the screw caps, and the housing 4 is provided with threaded holes 24 on an inner wall thereof, such that the screw portion 5 and the intermediate housing 25 are fixed with each other by the screws cooperating with the threaded holes 24. A connecting sheet 32 are riveted with the terminals 61 by rivets through the housing 4, in this case the rivets and the terminals 61 are connected with each other with an interference fit.

The baffle 22 is configured to insulate the first metal shrapnel 21 from the screw portion 5 for preventing short circuit. The fixing bases 23, the screws, the screw caps and the threaded holes 24 are configured to cooperate with each other to secure the screw portion 5, the intermediate housing 25 and the housing 4 altogether, and moreover to remain a space between the intermediate housing 25 and the housing 4 for heat dissipation and wiring.

### Fourth Embodiment

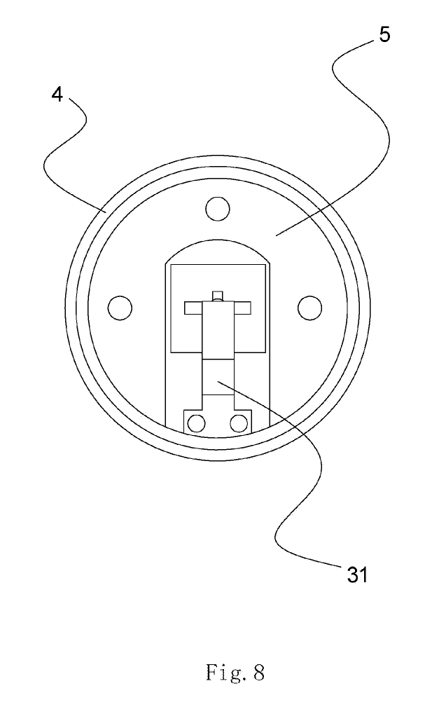

As shown in FIGS. 8 to 11, the first contact of the second adapter 3 is a second metal shrapnel 31 fixed on an inner wall of the housing 4 and having an elastic portion corresponding to the bottom interface 11 of the LED bulb body 1. The second contact of the second adapter 3 is the conductive screw portion 5 fixed inside the housing 4 and connected with the housing 4 by the connecting sheet 32. The connecting sheet 32 and the second metal shrapnel 31 are both fixed on an inner wall of the housing 4 by rivets. Specifically, the rivets extents through the connecting sheets 32 and the housing 4, and are riveted with the terminals 61 arranged outside the housing 4, in this case the rivets and the terminals 61 are connected with an interference fit. The connecting sheet 32 is provided with blocking sheets 33 at lateral sides thereof, for preventing the connecting sheet 32 from lateral displacement. The housing 4 is further provided with a top column 34 arranged on an inner wall thereof and under the second metal shrapnel 31, for jacking-up the second metal shrapnel 31. The screw portion 5 is fixed by the screws tightened in the threaded holes 24 provided in the housing 4.

The terminals 61, the second metal shrapnel 31 and the connecting sheet 32 can all be fixed on the housing 4 by the rivets in cooperation with the terminals 61, while the connecting sheets 32 in cooperation with the top columns 34 can provide space for heat dissipation and wiring between the screw portion 5 and the housing 4.

The following embodiment is given to illustrate the LED bulb body 1 in the first embodiment.

### Fifth Embodiment

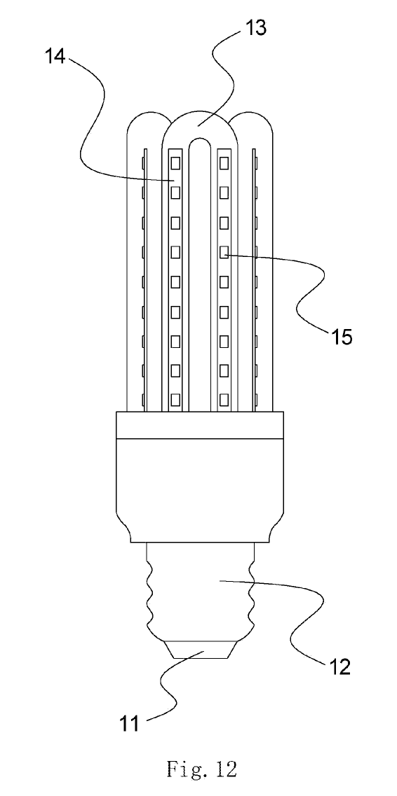

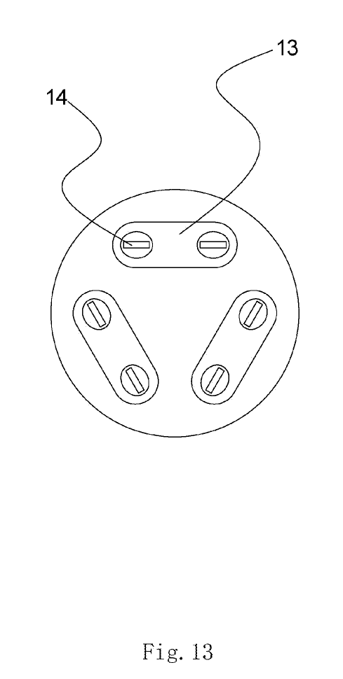

As shown in FIGS. 12 and 13, the LED bulb body 1 comprises a threaded bulb cap comprising the bottom interface 11 configured to connect with the first contact and the lateral interface 12 configured to connect with the second contact. The LED bulb body 1 further comprises three U-shaped bulb tubes 13 arranged circumferentially, each of which is provided with a bulb board 14 in each of two straight tube portions thereof. The bulb board 14 is provided with a plurality of LED chips 15 on a side thereof facing outwards, and a reflective coating layer on the side facing outwards. The LED bulb body 1 in the embodiment has uniform luminance and strong light intensity, can be used in the case of one simple U-shaped bulb tube 13 malfunctioning, makes the best use of the space inside the U-shaped bulb tube 13, and can provide space sufficient for heat dissipation.

### Sixth Embodiment

The LED bulb body 1 comprises a threaded bulb cap comprising the bottom interface 11 configured to connect with the first contact and the lateral interface 12 configured to connect with the second contact. The LED bulb body 1 further comprises three U-shaped bulb tubes 13 arranged circumferentially, each of which comprises a U-shaped wick matched in shape with the bulb tube. The U-shaped wick is provided with a plurality of LED chips 15 and enclosed by a plastic nonopaque sheath. Further, the plastic nonopaque sheath is coated with a light-strengthening powder layer, which can be a diamond shining powder layer with multi-reflecting surfaces, or a glass powder layer with multi-reflecting surfaces. The plastic nonopaque sheath in the embodiment enables the U-shaped wicks to have a U shape, and the use of the diamond shining powder layer or the glass powder layer allows the LED bulb body 1 to have a more uniform illumination, and substantially 360° reflecting surfaces.

The above embodiments are for purposes of illustration and description to the technical solutions of the present invention merely, but are not intended to limit the present invention. Any modification or equivalent replacement without departing from the spirit and scope of the present invention shall all fall within the scope of the technical solutions of the present invention.

What is claimed is:

1. A bulb and bulb holder adapter kit, comprising:
an LED bulb body (1) comprising a bottom interface (11) and a lateral interface (12); and
a bulb holder assembly comprising at least one first adapter (2) and at least one second adapter (3), each of which is provided at one end thereof with a screw portion (5), a first contact configured to connect with the bottom interface (11), and a second contact configured to connect with the lateral interface (12), and at the other end thereof with an insertion portion (6) and terminals (61) connected with the first contact and the second contact respectively,
wherein:
the screw portion (5) and the LED bulb body (1) are provided with screw threads matched therebetween,
the insertion portion (6) comprises a square column (62) for fixing the first adapter (2) or the second adapter (3) onto a socket, and pins (63) arranged on two opposing sides of the square column (62), and
each of the first adapter (2) and the second adapter (3) comprises a housing (4) sleeved on the screw portion (5), and the first adapter (2) further comprises an intermediate housing (25) arranged between the screw portion (5) and the housing (4).

2. The bulb and bulb holder adapter kit according to claim 1, wherein the insertion portion (6) further comprises a boss (64) having a kidney or rounded rectangular cross section, for connecting the square column (62) and the housing (4).

3. The bulb and bulb holder adapter kit according to claim 2, wherein the insertion portion (6) comprises at least two terminals (61), each of which at one end thereof is connected to the first contact and the second contact respectively and at the other end thereof extents through in turn and protrudes from the housing (4) and the boss (64).

4. The bulb and bulb holder adapter kit according to claim 2, wherein the boss (64) has a kidney-shaped cross section and the terminals (61) are arranged on two arc ends of the boss (64).

5. The bulb and bulb holder adapter kit according to claim 2, wherein the boss (64) has a rounded rectangular cross section, and the insertion portion (6) comprises four terminals (61) arranged on four corners of the rectangle, or two terminals (61) arranged on two opposing corners of either of diagonals of the rectangle.

6. The bulb and bulb holder adapter kit according to claim 1, wherein the square column (62) is provided with one or two pins (63) on each of two opposing sides thereof

7. The bulb and bulb holder adapter kit according to claim 1, wherein the length of the square column (62) of the first adapter (2) is larger than it of the square column (62) of the second adapter (3).

8. The bulb and bulb holder adapter kit according to claim 1, wherein the boss (64) of the first adapter (2) has a rounded square cross section, and the boss (64) of the second adapter (2) has a rounded rectangle cross section, wherein a long side of the rounded rectangle is equal to a side of the rounded square, and a short side of the rounded rectangle is less than the side of the rounded square.

9. The bulb and bulb holder adapter kit according to claim 1, wherein the intermediate housing (25) is provided with a guide groove (251) on an outer wall thereof, the housing (4) of the first adapter (2) is provided on an inner wall thereof with a bump (41) slidable in the guide groove (251).
